(19) United States
(12) Patent Application Publication
(10) Pub. No.: US 2026/0364996 A1
(43) Pub. Date: Nov. 19, 2026

(54) Rotary Machine And Primary Motor-Pump Assembly Provided With This Rotary Machine

(71) Applicant: Electricite de France, Paris (FR)

(72) Inventor: Julien Freychet, Rillieux La Pape (FR)

(73) Assignee: Electricite de France, Paris (FR)

(21) Appl. No.: 19/539,469

(22) Filed: Feb. 13, 2026

(30) Foreign Application Priority Data
Feb. 13, 2025 (FR) FR2501509

(51) Int. Cl. B60H 1/00; B01D 46/00; F16H 57/04

(52) U.S. Cl. CPC B60H 1/00849; B01D 46/0005; B01D 46/0031; F16H 57/045

(57) ABSTRACT

A rotating machine includes an oil-sealing device including an outside air suction grooving. The device includes, in a lower part of the wall and/or in a lower part of the rotating part, a grooving for suctioning air from a suction area located between the upper opening of the casing and the air suction grooving, the grooving extending from the area to an air collection area and being configured to suction air from the compartment through the area and through the opening of the casing toward the area when the shaft is rotating in the prescribed direction of rotation.

### CROSS-REFERENCE TO RELATED APPLICATIONS

This application claims priority from French application number FR2501509, filed Feb. 13, 2025, the disclosure of which is hereby incorporated herein by reference.

### BACKGROUND OF THE INVENTION

The invention relates to a rotating machine, as well as to a motor-driven pump unit equipped with this rotating machine.

### BRIEF SUMMARY OF THE INVENTION

The field of the invention generally relates to rotating machines needing to be lubricated with oil. This is for example the case of the motors of water-circulating pumps installed in the primary circuit of a nuclear power plant; these circulating pumps and their respective motors will, in the remainder of the text, be referred to as the primary motor-driven pump unit. The fields of application may be extended to turbines, pumps, motors, alternators, and any other item of machinery or machine comprising a rotary shaft.

From a first prior art, known by the document WO2022/248220 A1 a rotating machine is known including a casing, a rotary shaft mounted rotatably in the casing, the casing delimiting an oil compartment to lubricate the bearing, and an oil-sealing device including an outside air suction grooving located between a rotating part secured to the shaft and an upper part of the casing, to suction the air through this groove toward the compartment when the shaft is rotating in the prescribed direction of rotation.

Thus, in this known rotating machine, the oil compartment is pressurized with respect to the outside air, this pressurization being connected to the air inlet in the oil box by the grooving and to the pressure losses of the air vent filter connected to the compartment.

Thus, a first problem posed by this first prior art is that in the event of a failure of the static seal of the compartment, for example at a static joint, which is located elsewhere on the casing and which is supposed to seal the casing to contain the oil, air laden with oil is liable to contaminate the outside of the machine. In particular, for rotating machines of large dimensions, and especially for old (non-new) machines, it is sometimes complicated to correctly seal the bearings.

Furthermore, in a second prior art of other known rotating machines having, not a grooving but a sealing device with baffles and labyrinths, located between the rotating part and an upper part of the casing, operational experience feedback highlights problems of oil leaks via oil spray at the upper bearings of the motors of the motor-driven pump unit. Calculations and tests have confirmed that the rotation of the inertial flywheel creates a pressure loss and an acceleration of the air in the part under the flywheel.

Thus, a second problem posed by this second prior art is that the dynamic labyrinth sealing device does not make it possible to form an effective barrier to this pressure loss or to turbulence. As a result, oil backs up in the form of oil spray via this dynamic labyrinth sealing device from the oil compartment to the open air.

The invention has the aim of obtaining a rotating machine, and a primary motor-driven pump unit equipped with this rotating machine, which solve the first problem mentioned above and the second problem mentioned above and which make it possible to more robustly limit, or even more broadly eliminate oil leaks originating in the oil compartment.

For this purpose, a first subject matter of the invention is a rotating machine, including a casing, at least one rotary shaft along a prescribed direction of rotation, at least one guide bearing, which is mounted in the casing and in which the rotary shaft is rotatably mounted,
the casing delimiting a compartment intended to contain a volume of air and a volume of lubrication oil to lubricate the bearing,
the rotating machine including, in an upper opening of the casing, a rotating part, which is rotationally attached to the rotary shaft and which is surrounded, transversally to the rotary shaft and at a distance from the bearing, by a wall,
the rotating machine including an oil-sealing device, located between the rotating part and the wall, and a device for filtering the air of the compartment and for discharging the air to the outside of the compartment,
the oil-sealing device including at least one first grooving for suctioning outside air in the direction of rotation of the shaft,
characterized in that
the oil-sealing device includes, in a lower part of the wall and/or in a lower part of the rotating part, at least one second grooving for suctioning air in the direction of rotation of the shaft from a suction area, which is located between the upper opening of the casing and the second air suction grooving and which communicates firstly with the upper opening of the casing and secondly with a first air inlet,
the second air suction grooving extending from the suction area to an air collection area and being configured to suction air from the compartment through the suction area and through the upper opening of the casing toward the air collection area when the shaft is rotating in the prescribed direction of rotation,
the air collection area being located between the first outside air suction grooving and the second air suction grooving and being connected to a first air outlet, the first outside air suction grooving being located in an upper part of the wall and/or in an upper part of the rotating part and being configured to suction air from an opening of the upper part of the wall toward the air collection area, when the shaft is rotating in the prescribed direction of rotation.

Owing to the invention, the rotation of the shaft in the prescribed direction creates, via the second grooving, a pressure loss in the oil compartment with respect to the outside air. This pressure loss is due to the suction of the air by the second grooving when the shaft is rotating in the prescribed direction and due to the pressure loss of the first air inlet. The level of pressure loss of the oil compartment is very low (equal to the pressure loss of the first air inlet).

The invention thus makes it possible, via this pressure loss caused by the second grooving, to prevent, in the scenario where the casing delimiting the oil compartment is malfunctioning and includes an undesirable passage point, other than the upper opening of the casing (this leakage point being for example at a static joint of the casing), the oil-laden air from escaping from the inside of the compartment toward the outside via this passage point, which solves the first problem mentioned above and makes it possible to guarantee the sealing of the entire bearing, by forcing the outside air to go back in, due to this pressure loss, in the compartment via this leak point.

The invention also makes it possible to form an effective barrier to the turbulence present in the oil compartment and to prevent oil backing up as oil spray through the sealing device located at the upper opening of the casing from the oil compartment from being vented to the open air, which solves the second problem mentioned above.

According to an embodiment of the invention, the device for filtering the air of the compartment and for discharging the air to the outside of the compartment includes a second air inlet connected to the first air outlet, and further includes a first filter for separating the air and the oil received at the second air inlet,
the first filter being able to send the filtered oil to a filtered oil outlet, connected to an oil inlet of the compartment.

According to an embodiment of the invention, the device for filtering the air of the compartment and for discharging the air to the outside of the compartment includes a second air inlet connected to the first air outlet, a first filter for separating the air and the oil received at the second air inlet,
the first filter being able to send the filtered oil to a filtered oil outlet, connected to an oil inlet of the compartment, and to send the filtered air to a filtered air pipe provided between the first filter and an accessway for expelling filtered air, vented to the outside of the compartment.

According to another embodiment of the invention, the device for filtering the air of the compartment includes a second air inlet connected to the first air outlet, a first filter for separating the air and the oil received at the second air inlet,
the first filter being able to send the filtered oil to a filtered oil outlet, connected to an oil inlet of the compartment, and to send the filtered air to a filtered air pipe provided between the first filter and an air suction accessway of a motor-driven fan for extracting air to the outside of the compartment.

According to an embodiment of the invention, the first air inlet is connected to a filter for suctioning air from the outside, the first air inlet being between the suctioning filter and the suction area.

According to another embodiment of the invention, the first air inlet is connected to the filtered air pipe and opens into the filtered air pipe between the first filter and the accessway.

According to an embodiment of the invention, the suction area includes a first labyrinth for the passage of the air and/or a first baffle for the passage of the air.

According to an embodiment of the invention, the air collection area includes a second labyrinth for the passage of the air and/or a second baffle for the passage of the air.

According to an embodiment of the invention, the air collection area includes at least one air-guiding wall, which is located at a distance between the first outside air suction grooving and the second air suction grooving and at a distance from these,
the at least one air-guiding wall extending along a common guiding direction of the air coming from the first outside air suction grooving against a first face of the air-guiding wall and of the air coming from the second air suction grooving against a second face of the air-guiding wall toward the first air outlet,
the second face of the air-guiding wall being opposite the first face of the guiding wall,
the air collection area further including an air mixing area located at one end of the air-guiding wall, which is located downstream along the guiding direction,
the air mixing area being located between the air-guiding wall and the first air outlet.

According to an embodiment of the invention, the first outside air suction grooving is inclined by a first determined, non-zero, angle of inclination with respect to a plane transverse to the shaft and extends around a direction of extension of the shaft, around which the shaft is able to rotate in the prescribed direction of rotation,
the second air suction grooving is inclined by a second determined, non-zero, angle of inclination with respect to the plane and extends around the direction of extension of the shaft,
the first angle being oriented in the reverse direction to the second angle with respect to the plane.

According to an embodiment of the invention, the first outside air suction grooving is helical around the direction of extension of the shaft,
the second air suction grooving is helical around the direction of extension of the shaft.

According to an embodiment of the invention, the wall, the first air inlet, the suction area, the first outside air suction grooving, the second air suction grooving, the opening of the upper part of the wall, the air collection area and the first air outlet are integral parts of a removable module, including at least one first removable connection fitting to removably connect the suction area to the upper opening of the casing.

A second subject matter of the invention is a primary motor-driven pump unit, intended to be mounted in at least one pressurized primary water circuit of a nuclear electrical power production plant, the primary motor-driven pump unit including a primary pump with a water pump impeller and a rotating machine as described above, the rotary shaft of which is attached to the pump impeller of the primary pump for its rotational driving.

According to an embodiment of the invention, the primary motor-driven pump unit includes an inertial flywheel attached to the rotary shaft, the rotating part being an annular wall secured to the inertial flywheel and extending around the rotary shaft.

### DESCRIPTION OF THE DRAWINGS

The invention will be better understood on reading the following description, given solely by way of non-limiting example with reference to the figures below of the appended drawings.

FIG. 1 shows a schematic vertical section view of a known rotating machine.

FIG. 2 shows a schematic magnified vertical section view of the known rotating machine of FIG. 1.

FIG. 3 shows a schematic perspective view of a primary circuit of a nuclear electrical power production plant in which the rotating machine according to an embodiment of the invention can be mounted.

FIG. 4 shows a schematic open perspective view of a primary motor-driven pump unit of the primary circuit of FIG. 3, which can include the rotating machine according to an embodiment of the invention.

FIG. 5 shows a schematic vertical section view of a part of the primary motor-driven pump unit of the primary circuit of FIG. 4, which may include the rotating machine according to an embodiment of the invention.

FIG. 6 shows a schematic vertical section view of a part of the rotating machine according to an embodiment of the invention, in a normal mode.

FIG. 7 shows a schematic vertical section view of a part of the rotating machine according to an embodiment of the invention, in a degraded mode.

FIG. 8 shows a schematic vertical section view of a part of the rotating machine according to a variant of the invention, in the normal mode.

### DETAILED DESCRIPTION

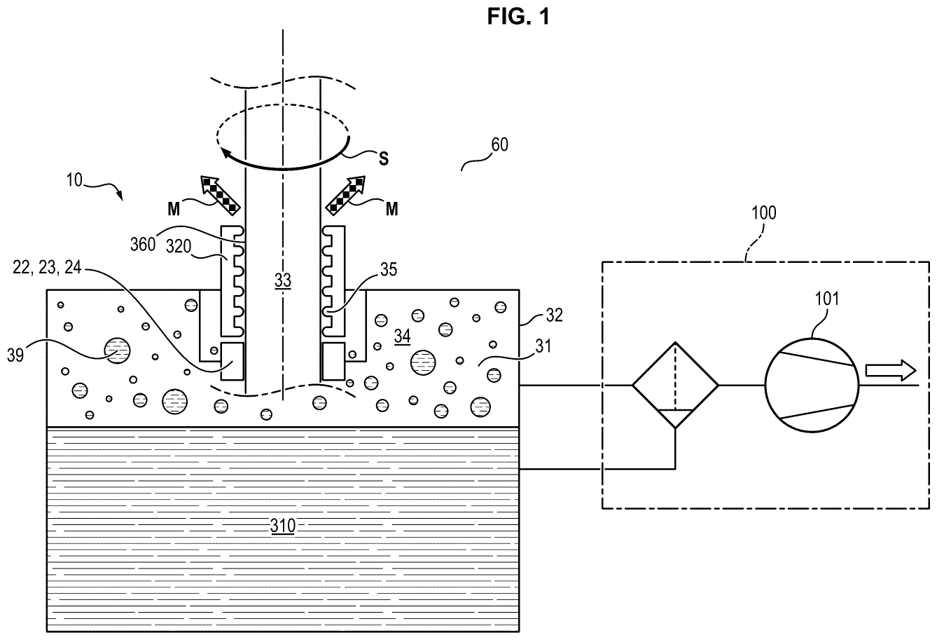

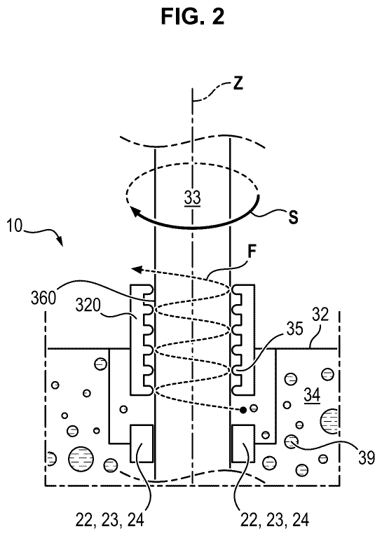

In general, with reference to FIGS. 1 and 2, a rotating machine 10 known in the second prior art mentioned above includes a casing 32, a rotary shaft 33 on guide bearings 22, 23, 24, the casing 32 containing a volume 310 of lubrication oil to lubricate the bearings 22, 23, 24. The rotating machine 10 includes a rotating part 360, rotationally attached to the rotary shaft 33. The rotating machine 10 includes an oil-sealing device 35, located between a rotating part 360 secured to the shaft 33 and an upper part 320 of the casing 32.

In the field of rotating machines 10 for a primary motor-driven pump unit formed by a motor mounted in the primary circuit of a nuclear electrical power production plant, such sealing devices 35 are known, formed by a system 35 of baffles and labyrinths, located between the rotating part 360 and the upper part 320 of the casing 32, as shown in FIGS. 1 and 2.

This device 35 is named “sealing device” in common parlance due to the fact that it fulfils a function of limiting lubricant leakage from the casing 32 to the outside of that casing.

This limiting of leaks does not lead to complete sealing. However, it is a function of several parameters including, for example, and without limitation:
the length of the baffles: the longer they are, the more the limiting of the leaks is improved,
the number of teeth disposed between the baffle and the rotating part: the greater in number they are, the more the limiting of the leaks is improved,
the distance between the rotating part 360 and the end of the teeth of the labyrinths: the smaller it is, the more the limiting of the leaks is improved,
pressure and velocity fluctuations originating in rotary members including the rotary shaft 33 itself, combined with the presence of an inertial flywheel 36 in the case of a primary motor-driven pump unit: the smaller they are, the more the limiting of the leaks is improved.

Thus, the second problem mentioned above, posed by the second prior art mentioned above of the rotating machine 10 with a sealing device 35 with baffles and labyrinths, is that the rotation of the shaft 33 and the presence of oil 310 in the casing give rise to oil leaks to the outside at the sealing device 35 between the shaft 33 and the casing 32. The pressure variations and turbulence related to the operation of the motor (rotation of the shaft 33 in particular) allow the oil to migrate by diffusion and to traverse the sealing device 35 in place. Specifically, the rotation of the shaft 33 in contact with the oil creates oil spray, which escapes via the sealing device 35 between the shaft 33 and the casing 32, forming a leakage path, as shown by the arrow F on FIG. 2. The oil-laden air is thus released into the environment of the rotating machine 10, along the arrow M shown in FIG. 1, and will give rise to contamination by oil on different surfaces and equipment located near the rotating machine 10.

With reference to FIGS. 1 and 2, in certain of said known rotating machines 10 having the baffle and labyrinth sealing device 35 of the second prior art mentioned above, provision is made, for the purpose of limiting oil leaks at the device 35, for a device 100 for filtering the oil-laden air coupled with a motor-driven fan 101. Said filtering device 100 is intended to ensure the separation of the oil contained in the air, this oil being reinjected into the casing 32. Said motor-driven fan 101 provides a depressurization of the casing 32 with respect to the outside pressure of the machine generating a stream of air coming from the outside of the machine and traversing the sealing device 35, which has the effect of limiting the backing-up of oil mist 39 from the casing 32 through the sealing device 35.

This known rotating machine 10 has the drawback of requiring a motor-driven fan/ extractor 101 which must be supplied with electricity to operate (or even be mechanically driven). This type of motor-driven fan/extractor 101 firstly has a high installation cost, particularly in a nuclear power plant, and this is due to the large number of components to be installed such as outgoing electrical lines, cables and control/command. Moreover, such an installation gives rise to additional maintenance costs, including routine maintenance of the motor-driven fan/extractor 101 (replacement of bearings, mechanical servicing). And finally, such an installation gives rise to high operating costs due to the high electrical power consumption of the motor-driven fan.

Moreover, the dynamic sealing of the primary pump motor bearings has been the subject of several modifications (including the shape of the labyrinth 35, increase in the number of teeth composing it, addition of fins under the cowl 38 of the inertial flywheel 36). However, these modifications do not guarantee a low level of oil leakage.

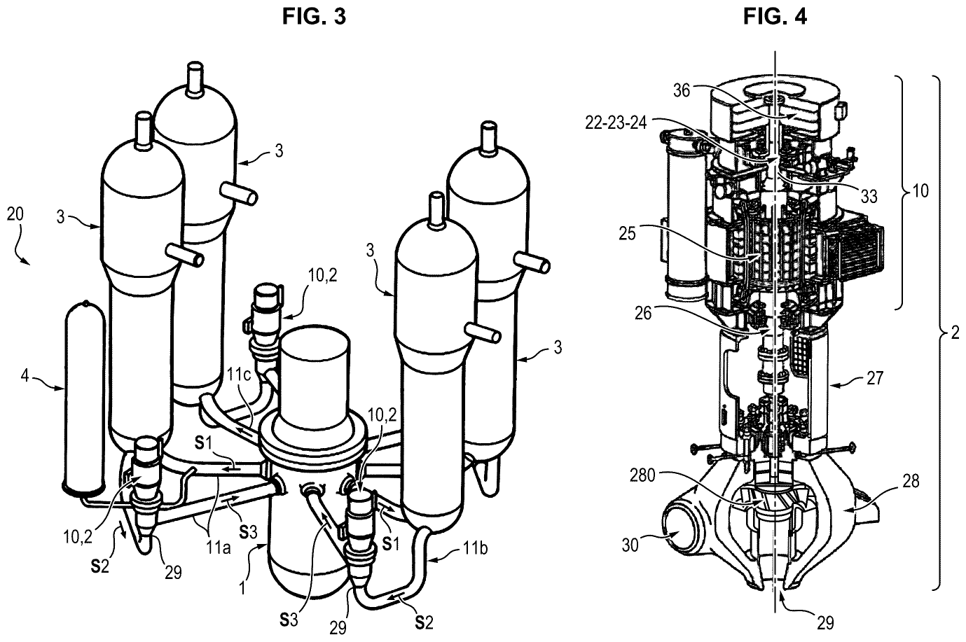

In general, in FIGS. 3 to 8, the rotating machine 10 according to the invention includes a casing 32, at least one rotary shaft 33 along a prescribed direction S of rotation, at least one guide bearing 22, 23, 24, which is mounted in the casing 32 and in which the rotary shaft 33 is rotatably mounted. In an embodiment of the invention, the rotating machine 10 can operate as a motor. In another embodiment, the rotating machine 10 can operate as a generator. The rotary shaft 33 is able to rotate about a direction D of extension of the shaft 33 in the prescribed direction S of rotation. The casing 32 delimits a compartment 31 intended to contain a volume 34 of air and a volume of liquid lubrication oil 310 to lubricate the bearing 22, 23, 24.

The rotating machine 10 includes a rotating part 360, rotationally attached to the rotary shaft 33. The rotary shaft 360 passes through an upper opening 322 of the casing 32. The rotating part 360 is surrounded, transversally to the rotary shaft 33 and at a distance from the bearing 22, 23, 24, by a wall 320. The rotating part 360 surrounds the rotary shaft 33 and may be annular around the direction D of extension of the shaft 33 and for example circular-cylindrical around this direction D. The rotating machine 10 includes in the upper opening 322 of the casing 32 a feedthrough 50 of the shaft 33 in the casing 32. In this feedthrough 50, the rotating part 360 faces and is surrounded by the wall 320 transversally to the rotary shaft 33 and at a distance from the bearing 22, 23, 24. The wall 320 may be annular around the direction D of extension of the shaft 33 and may be circular-cylindrical around this direction D.

The rotating machine 10 includes an oil-sealing device 35, located between the rotary rotating part 360 and the wall 320, and a device 100 for filtering the air of the compartment 31, which is intended to separate the air from the oil. The oil-sealing device 35 is located at a distance from the bearing 22, 23, 24. The shaft 33 traverses the casing 32 and the oil-sealing device 35. According to an embodiment of the invention, the air filtering device 100 is configured to reinject oil that has been caught in this filtering device 100 into the volume of oil 310.

In FIGS. 3, 4 and 5, an example of use of the rotating machine 10 according to the invention is a primary motor-driven pump unit 2, mounted in the primary circuit 20 of a nuclear power production plant. The primary motor-driven pump unit 2 includes a primary pump 28 with a water pump impeller 280 and the rotating machine 10 according to the invention, operating as a motor. The rotary shaft 33 is attached to the pump impeller 280 of the primary pump 28 so that the rotation of the shaft 33 drives the rotation of the pump impeller 280. Of course, the rotating machine 10 according to the invention could be used elsewhere than in a primary motor-driven pump unit 2. Other examples of use are the sealing of bearings of turbines, alternators, pumps, and motors.

In FIG. 3, the primary water-circulating circuit 20 of the nuclear power plant, for example with a pressurized water reactor, comprises one or more primary water-circulating loops 11a, 11b, 11c, which are connected to a water vat 1. In each primary water-circulating loop 11a, 11b, 11c there is a primary motor-driven pump unit 2, a steam generator 3 for sending water successively from the vat 1 to the steam generator (in the direction S1 of circulation of the water), then from the steam generator 3 to an upstream water inlet channel 29 of the primary motor-driven pump unit 2 (in the direction S2 of circulation of the water), and finally from a downstream water outlet channel 30 of the primary motor-driven pump unit 2 (in the direction S3 of water circulation) to the vat 1. One of the primary loops 11a, 11b, 11c, for example the primary loop 11a, comprises a water pressurizer intended to control the pressure throughout the primary circuit 20.

An example of a primary motor-driven pump unit 2 including the rotating machine 10 operating as a motor is shown in more detail in FIG. 4 and includes, from top to bottom:
an inertial flywheel 36, attached to an upper part of the rotary shaft 33,
the upper guide bearing 22, 23, 24, consisting of the upper radial guide bearing 22 and by a double stop, namely the lower axial stop bearing 24 and the upper axial stop bearing 23,
-a rotor-stator assembly 25, the rotor of which is attached to a median part of the rotary shaft 33 and the stator of which is attached to the casing 32, the stator being able to rotationally drive the rotor and the rotary shaft 33,-the lower radial guide bearing 26,-a motor support 27, attached to the lower part of the frame 32 of the motor,-a primary pump 28 consisting of its volute, its pump impeller 280, its diffuser, and its sealing device and its pivot members.
   The lower bearing 26 has its own oil casing (different from the upper bearing 22,23,24) and its own oil and is therefore not concerned by the leakage problems according to the invention (separate from that of the upper bearing).

As per FIG. 1, to ensure the operation of the rotating machine 10 (and of the primary motor-driven pump unit 2 if the rotating machine 10 is used therein) and limit friction, the pivoting members 22, 23, 24 of the rotating machine 10 such as the radial guide bearings 22 and the axial stop bearings 23, 24 are lubricated with oil 310 located in the compartment 31 of the casing 32.

In operation, with reference to FIG. 1, an oil mist 39 is generated due to the rotation of the shaft 33 and the operation of the bearings 22, 23, 24, particularly the upper guide bearing 22, to such an extent that the air 34 located above the level 313 of oil 310 in the compartment 31 is laden with a fine mist 39 of oil and oil vapor. More than 95% of the oil droplets of this mist 39 have a size between 0.15 and 1.0μm.

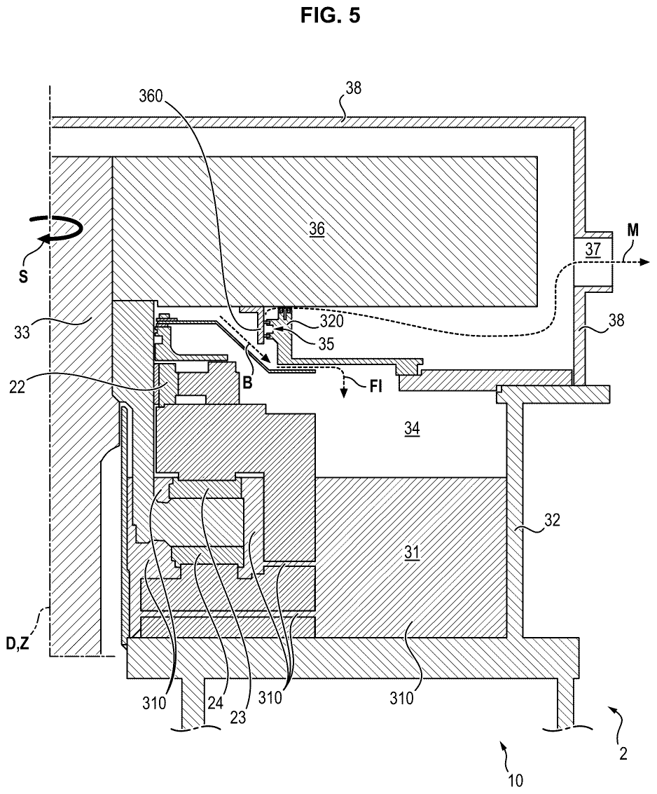

This mist 39 circulates along the path B as shown in FIG. 5 in the scenario of the second prior art of FIGS. 1 and 2, mentioned above, said mist 39 diffusing into two paths that separate, the first along an internal leak path FI, the second along an outer leak path F traversing the seal 35 and giving rise to an outer global leak path M laden with oil that the present invention proposes to limit or to eliminate owing to the dynamic control of the leak F.

In this second prior art of FIGS. 1 and 2, the dynamic seal between the oil casing 32 and the rotating part 360 of the rotating machine 10 is provided by a system of baffles/labyrinths 35. This dynamic sealing device 35 has the aim of avoiding transfers of mist/oil vapor 39 from the inside of the casing 32 to the outside 60 of the casing 32.

Nonetheless, the second prior art of FIGS. 1 and 2, mentioned above, poses the second problem mentioned below, namely that the pressure fluctuations and circulations of air related to the operation of the rotating machine 10, particularly the rotation of the shaft 33, allow the air 34 laden with oil 39 to migrate by diffusion and to traverse the dynamic seal 35 in place, as illustrated by the arrows M shown in FIG. 1. The air 34 laden with oil 39 is released along the arrows M into the environment 60 of the rotating machine 10 and will undesirably generate contamination by the oil on different surfaces and equipment near the rotating machine 10 outside the compartment 31 of the casing 32. In the case of the primary motor-driven pump unit 2 of FIGS. 3 to 5, this phenomenon is emphasized by the presence of the inertial flywheel 36, and this air 34 laden with oil 39 is then expelled toward the outside 60 of the rotating machine 10 via the ventilation holes 37 of the casing 38 for protecting the inertial flywheel 36 of the rotating machine 10.

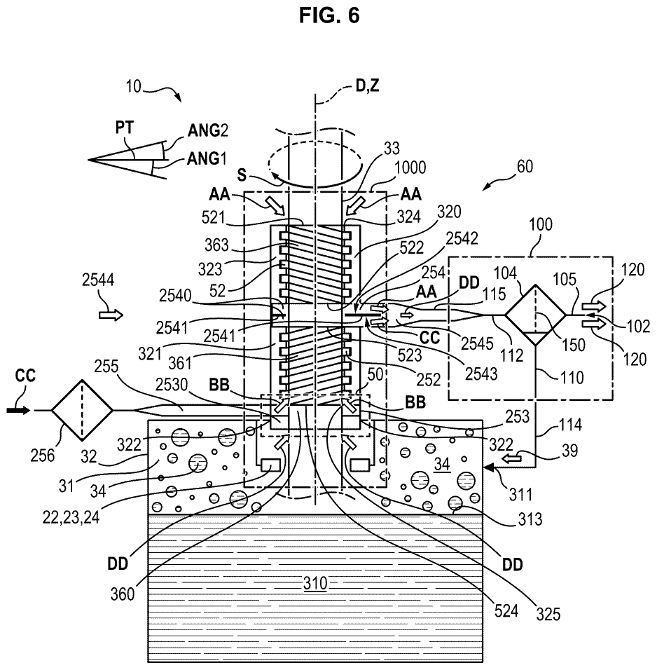

To solve the second problem mentioned above, which is related to the second prior art, mentioned above, of FIGS. 1 and 2, this invention has the aim of limiting or even eliminating all these drawbacks by making provision for an installation providing dynamic sealing on rotating machines 10 in operation, by an installation incorporated from the point of manufacturing and implementation of these rotating machines 10. The invention has the aim of significantly reducing the leaks M of oil by oil spray/oil mist emitted into the atmosphere by the rotating machines 10 requiring a lubrication of FIGS. 6, 7 and 8, such as for example the motors of water-circulating pumps operated in nuclear power stations according to FIGS. 3 to 5.

According to the invention, and as illustrated by FIGS. 6, 7 and 8, the oil-sealing device 35 includes one (or more) first grooving 52 for suctioning outside air in the direction S of rotation of the shaft 33.

The oil-sealing device 35 includes, in a lower part 321 of the wall 320 and/or in a lower part 361 of the rotating part 360, one (or more) second air suction grooving 252 in the direction S of rotation of the shaft 33 from a suction area 253. The suction area 253 is located between the upper opening 322 of the casing 32 and the second air suction grooving 252. The suction area 253 communicates on the one hand with the upper opening 322 of the casing 32 and on the other hand with a first air inlet 255. The first air inlet 255 allows a stream of air entering the suction area 253 through the first air inlet 255 and makes it possible to create a pressure drop which sets up a pressure loss inside the oil compartment 31 with respect to the outside air.

The second air suction grooving 252 extends from the suction area 253 to an air collection area 254. The second air suction grooving 252 is configured to suction air from the compartment 31 through the suction area 253 and through the upper opening 322 of the casing 32 towards the air collection area 254 when the shaft 33 is rotating in the prescribed direction S of rotation. Thus, the second air suction grooving 252 is configured to suction air from the suction area 253 to the air collection area 254 when the shaft 33 is rotating in the prescribed direction S of rotation, and therefore from the upper opening 322 of the casing 32 to the air collection area 254 and to the first air outlet 115. The oil-laden air of the compartment 31 is thus expelled toward the outside via the first air outlet 115.

The air collection area 254 is located between the first outside air suction grooving 52 and the second air suction grooving 252. The air collection area 254 is connected to a first air outlet 115.

The first outside air suction grooving 52 is located in an upper part 323 of the wall 320 and/or in an upper part 363 of the rotating part 360. The first outside air suction grooving 52 extends from an opening 324 of the upper part 323 of the wall 320 to the air collection area 254. The first outside air suction grooving 52 is configured to suction air from the opening 324 of the upper part 323 of the wall 320 toward the air collection area 254, when the shaft 33 is rotating in the prescribed direction S of rotation.

The air collection area 254 is located between the upper part 323 of the wall 320 and the lower part 321 of the wall 320.

Thus, the second air suction grooving 252 of the invention makes it possible to create a pressure loss in the volume 24 of air of the oil compartment with respect to the outside air, when the shaft 33 is rotating in the prescribed direction S of rotation. The air stream suctioned by the first outside air suction grooving 52 from the opening 324 of the upper part 323 of the wall 320 to the air collection area 254 (arrows AA of FIGS. 6, 7 and 8) acts as a barrier to backups of oil-laden air (arrows DD and EE of FIGS. 6, 7 and 8), which are sent via the second air suction grooving 252 from the suction area 253 to the air collection area 254.

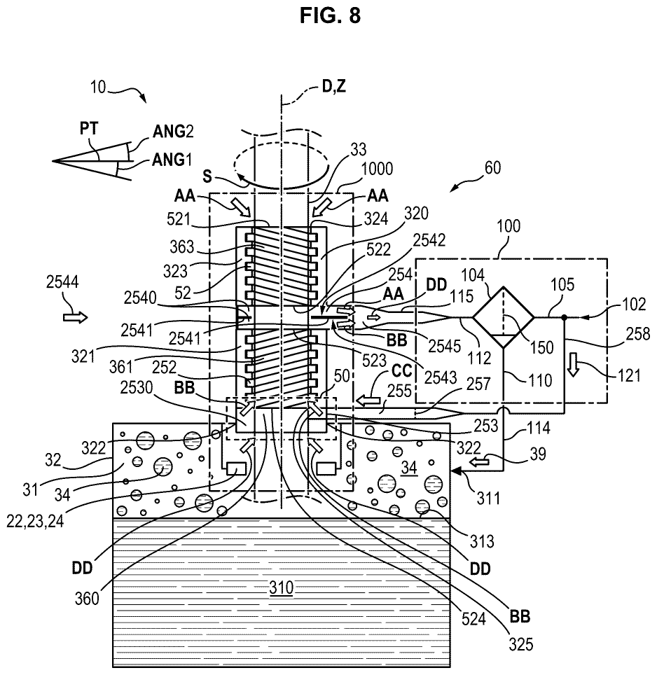

In a first scenario of normal operation, as shown in FIGS. 6 and 8, there are no leaks from the casing 32 delimiting the oil compartment 31 away from the upper opening 322, and the static sealing of the bearing and of the oil compartment 31 is ensured, for example by the static joints of the bearing (apart from dynamic sealing). In this scenario, the great majority of the air suctioned by the second grooving 252 comes from the first air inlet 255 (arrows BB and CC in FIGS. 6 and 8) and a relatively small part of it comes from the inside of the oil compartment 31 (arrows DD in FIGS. 6 and 8).

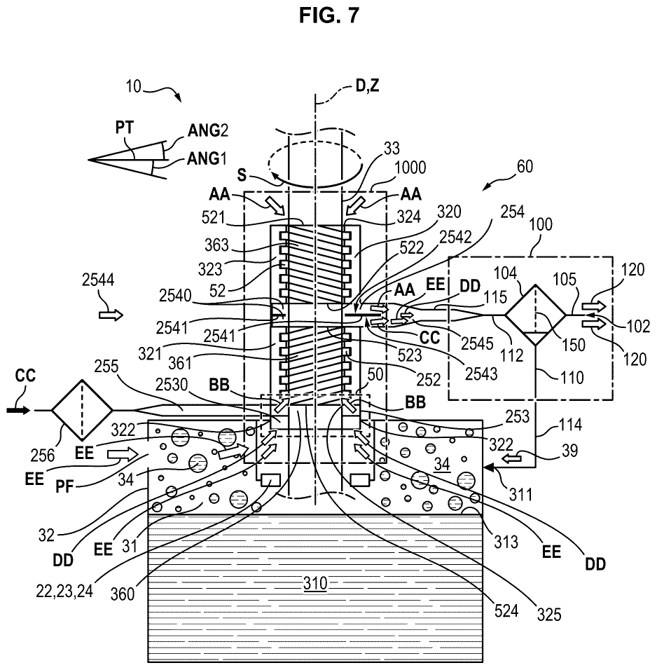

In a second scenario of degraded operation, as shown in FIG. 7, a passage point PF (or malfunction area PF) of the casing 32 appears, for example due to a malfunction of a static joint of the bearing (apart from dynamic sealing), away from the upper opening 32. In the absence of the invention, such a passage point PF causes a leak of oil or oil-laden air from the compartment 31 toward the outside via this passage point PF and it is considered that the static sealing of the bearing and of the oil compartment 31 is no longer completely assured.

In this second scenario of degraded operation, as shown in FIG. 7, the invention ensures that the air suctioned by the second grooving 252 during the rotation of the shaft 23 in the prescribed direction S of rotation causes a pressure loss in the oil compartment 31 with respect to the outside air. Thus, outside air not laden with oil will be suctioned from the outside via the passage point PF from the casing 32 toward the compartment 31, which prevents the oil-laden air from escaping through this passage point PF. This makes it possible to solve the first problem mentioned above, while also solving the second problem mentioned above. The suction air comes in part from the first air inlet 255 (arrows BB and CC in FIG. 7), the other part of the suctioned air coming from the inside of the oil compartment 31 (arrows DD in FIG. 7) and from the outside air passing through the passage point PF (arrows EE).

One or more grooves may be provided in the first air suction grooving 52.

According to an embodiment of the invention, as illustrated in FIGS. 6, 7 and 8, the rotating part 360 (or rotor) secured to the shaft 33 is without contact with the wall 320 (or stator) of the casing 32, the first air suction grooving 52 being located between the rotating part 360 secured to the shaft 33 and the wall 320. Thus, the sealing device 35 is without contact in the feedthrough 50 of the shaft 33 in the casing 32.

According to an embodiment of the invention, as illustrated in FIGS. 6, 7 and 8, the first air suction grooving 52 extends from the opening 324 located at an upper air suction end 521 of the rotating part 360 and/or of the upper part 323 of the wall 320 to an upper intermediate part 522 for expelling air of the rotating part 360 and/or of the upper part 323 of the wall 320. The upper air suction end 521 is located on the side of an air communication opening 37 of the rotating machine 10 with the outside 60. The upper intermediate air expelling part 522 opens into the air collection area 254.

According to an embodiment of the invention, the first air suction grooving 52 is configured (oriented) to suction air (arrows AA in FIGS. 6 and 7) from the upper end 521 to the upper intermediate part 522, i.e. from the opening 37, 324 of communication of air toward the air collection area 254, when the shaft 33 is rotating in the prescribed direction S of rotation.

According to an embodiment of the invention, as illustrated in FIGS. 6, 7 and 8, the second air suction grooving 252 extends from the opening 325 located at a lower air suction end 524 of the rotating part 360 and/or of the lower part 321 of the wall 320 to a lower intermediate air expelling part 523 of the rotating part 360 and/or of the lower part 321 of the wall 320. The lower air suction end 524 opens into the suction area 253. The lower intermediate part 523 for ejection of air is located lower down than the upper intermediate air expelling part 522. The lower intermediate air expelling part 524 opens into the air collection area 254.

According to an embodiment of the invention, the second air suction grooving 252 is configured (oriented) to suction air (arrows BB in FIGS. 6, 7 and 8) from the lower air suction end 524, i.e. from the suction area 253, toward the lower intermediate air expelling part 523, i.e. toward the air collection area 254, when the shaft 33 is rotating in the prescribed direction S of rotation.

According to an embodiment of the invention, illustrated in FIGS. 1 to 8, the rotary shaft 33 is vertical and is able to rotate in the prescribed direction S of rotation about the direction D of extension of the shaft 33, which is the vertical direction Z.

According to another embodiment of the invention, not shown, the rotary shaft 33 is not vertical and is able to rotate in the prescribed direction S of rotation around the direction D of extension of the shaft 33, which is not parallel to the vertical direction Z. The spatial orientation of the direction D of extension can be of more than 0 degrees with respect to an horizontal plane.

In the remainder of the text, reference will be made to a rotating machine 10 of rotary shaft 33 shown along a vertical axis D, Z—i.e. at an angle of 90 degrees with respect to the horizontal plane—, however the scope of the invention relates to any type of rotating machine whatever the spatial orientation of the axis D of rotation, which can also be between 0 and 90 degrees with respect to said horizontal plane.

According to an embodiment of the invention, illustrated in FIGS. 6, 7 and 8, the first air suction groove 52 is continuous from the opening 324 of the upper part 323 of the wall 320 to the air collection area 254.

According to an embodiment of the invention, illustrated in FIGS. 6, 7 and 8, the second air suction grooving 252 is continuous from the suction area 253 to the air collection area 254.

According to an embodiment of the invention, illustrated in FIGS. 6, 7 and 8, the first outside air suction grooving 52 is inclined by a first determined, non-zero, angle ANG1 of inclination with respect to a plane PT transverse (normal) to the shaft 33 and extends around a direction D of extension of the shaft 33, around which the shaft 33 is able to rotate in the prescribed direction S of rotation. For example, in the case where the direction D of the shaft 33 is vertical, the plane PT is horizontal.

According to an embodiment of the invention, illustrated in FIGS. 6, 7 and 8, the determined angle ANG1 with respect to the transverse plane PT is between 0 and 60 °, particularly between 1 ° and 45 °, for example between 1 ° and 25 °. The number of grooves of the grooving 52 connecting to one another along the direction D, their depth in the transverse plane PT, their shape, their angle ANG1 with the normal to the direction D of extension, the length of the sealing device 35 along the direction D of extension and the radial clearance (in the direction of the transverse plane PT, starting from the direction D) between the outer diameter of the rotating part 360 and the inner diameter of the wall 320 are a function of the geometry of the area 50 to be sealed and on the functional parameters of the machine (vibration level, clearances at the bearings etc.). According to an embodiment of the invention, on the primary pump motors 28, the number of grooves is greater than or equal to 1 and less than or equal to 150, the depth of the grooves 52 is between 0 and 30 mm, the angle ANG1 of the grooves with the normal to the direction D of extension is between 0 and 60 °, the length of the sealing device 35 along the direction D of extension is between 0 and 200 mm, and the radial clearance between the outer diameter of the rotating part 360 and the inner diameter of the upper part 320 is greater than 0 mm and less than or equal to 6 mm.

The second air suction grooving 252 is inclined by a second, non-zero, determined angle ANG2, of inclination with respect to the direction D of extension of the shaft 33.

The first angle ANG1 is oriented in the reverse direction to the second angle ANG2 with respect to the plane PT. The first angle ANG1 can have the same absolute value with respect to the plane PT as the second angle ANG2, and be of an opposite sign to that of the second angle ANG2 with respect to the plane PT.

According to an embodiment of the invention, illustrated in FIGS. 6, 7 and 8, the determined angle ANG2 with respect to the transverse plane PT is between 0 and 60 °, particularly between 1 ° and 45 °, for example between 1 °and 25 °. The number of grooves of the grooving 252 connecting one after the other along the direction D, their depth in the transverse plane PT, their shape, their angle ANG2 with the normal to the direction D of extension, the length of the sealing device 35 along the direction D of extension and the radial clearance (in the direction of the transverse plane PT, starting from the direction D) between the outer diameter of the rotating part 360 and the inner diameter of the wall 320 are a function of the geometry of the area 50 to be sealed and of the functional parameters of the machine (vibration level, clearances at the bearings etc.). According to an embodiment of the invention, on the primary pump motors 28, the number of grooves is greater than or equal to 1 and less than or equal to 150, the depth of the grooves 52 is between 0 and 30 mm, the angle ANG2 of the grooves with the normal to the direction D of extension is between 0 and 60 °, the length of the sealing device 35 along the direction D of extension is between 0 and 200 mm, and the radial clearance between the outer diameter of the rotating part 360 and the inner diameter of the upper part 320 is greater than 0 mm and less than or equal to 6 mm.

The number of grooves connecting one after another along the direction D, their depth in the transverse plane PT, their shape, their angle with the normal in the direction D of extension, the length of the sealing device 35 along the direction D of extension and the radial clearance may be different or identical for the first outside air suction grooving 52 and for the second air suction grooving 252.

According to an embodiment of the invention, illustrated in FIGS. 6, 7 and 8, the first outside air suction grooving 52 is in the form of a screw from the opening 324 of the upper part 323 of the wall 320 to the air collection area 254 in the prescribed direction S of rotation. This may be a particular implementation of the determined angle ANG1, of the number of grooves (each groove in this case being a thread making one turn around the direction D and the grooves being connected to one another along the direction D), the depth, the length and the clearance.

According to an embodiment of the invention, illustrated in FIGS. 6, 7 and 8, the first outside air suction grooving 52 is helical around the direction D of extension of the shaft 33. This may be a particular implementation of the determined angle ANG1, of the number of grooves (each groove being in this case a thread making one turn around the direction D and the grooves being connected to one another along the direction D), the depth, the length and the clearance.

The first outside air suction grooving 52 thus forms a first outside pump screw for the air from the opening 324 of the upper part 323 of the wall 320 to the air collection area 254 when the shaft 33 is rotating in the prescribed direction S of rotation, and therefore from the opening 324 of the upper part 323 of the wall 320 to the first air outlet 115.

According to an embodiment of the invention, illustrated in FIGS. 6, 7 and 8, the second air suction grooving 252 is in the form of a screw from the suction area 253 to the air collection area 254 in the prescribed direction S of rotation. This may be a particular implementation of the determined angle ANG2, of the number of grooves (each groove being in this case a thread making one turn around the direction D and the grooves being connected to one another along the direction D), the depth, the length and the clearance.

According to an embodiment of the invention, illustrated in FIGS. 6, 7 and 8, the second outside air suction grooving 252 is helical around the direction D of extension of the shaft 33. This may be a particular implementation of the determined angle ANG2, of the number of grooves (each groove being in this case a thread making one turn around the direction D and the grooves being connected to one another along the direction D), the depth, the length and the clearance.

The second air suction grooving 252 thus forms a second pump screw for the air from the suction area 253 to the air collection area 254 when the shaft 33 is rotating in the prescribed direction S of rotation, and therefore from the upper opening 322 of the casing 32 to the air collection area 254 and to the first air outlet 115.

In the case where the first angle ANG1 has the same absolute value in relation to the plane PT as the second angle ANG2 and is of opposite sign to the second angle ANG2 in relation to the plane PT, the first outside pump screw has a reverse screw pitch to that of the second pump screw.

According to an embodiment of the invention, illustrated in FIGS. 6 and 7, the first air inlet 255 is connected to an air suction filter 256 from the outside. The first air inlet 255 is located between the suction filter 256 and the suction area 253. The suction filter 256 allows a stream of incoming air into the suction area 253 via the first air inlet 255, to create a pressure drop which sets up a pressure loss inside the oil compartment 31 with respect to the outside air (a pressure loss which is a direct function of the pressure drop of the filter 256) and to purify the air entering the suction area 253 and thus to guarantee the absence of contamination in the bearing and the venting system.

In a variant, shown in FIG. 8, at the air suction filter 256 of this last embodiment described above, the first air inlet 255 is connected to the filtered air pipe 105 and opens into the filtered air pipe 105 between the first filter 104 and the accessway (accessway 102 for expelling filtered air, vented, or air suction accessway of the motor-driven fan for extracting air to the outside). There is therefore a filtered air recirculating channel 258 connecting the filtered air pipe 105 to the first air inlet 255, this filtered air recirculating channel 258 opening into the filtered air pipe 105 between the first filter 104 and the accessway (accessway 102 for expelling filtered air, vented, or air suction accessway of the motor-driven fan for extracting air to the outside). One may thus dispense with the air suction filter 256 in this variant.

Thus, in this variant, the air suctioned by the second air suction grooving 252 is taken directly at the outlet of the venting system 100, namely at the filtered air pipe 105. This provision, owing to the recirculating of a part of the decontaminated air of the filtered air pipe 105 in the channel 258, improves the efficiency of the device and saves on the use of the air suction filter 256, which decreases its installation cost. Specifically, in the filtered air pipe 105 at the outlet of the venting system 100, the air coming out of the filter 104 is clean (no particulate or dust) and free of any oil (99% free). The fact of adding a recirculation makes it possible firstly to reduce the outgoing flow of decontaminated air 120 via the accessway (filtered air-expelling accessway 102, vented, or air suction accessway of the motor-driven fan for extracting air to the outside), and secondly, the recycled air 121 in the inlet 255, drawn off the filtered air pipe 105, passes through the filter 104 once more, which makes it possible to purify it better owing to the second passage through the filter 104.

To operate this variant, attention should be paid to two important points.

A first important point is that the suction pressure of the second air suction grooving 252 must remain less than the ambient pressure (so as to guarantee the setting-up of the pressure loss in the oil compartment 31). To achieve this, if the major and minor pressure drops of the supply line (255, 258) of the second air suction grooving 252 are insufficient, minor pressure drops may be added on the first air inlet 255, for example by diaphragms 257 provided in the first air inlet 255 or in the filtered air recirculating channel 258.

A second important point is that to avoid the heating of the recirculated air 121, the flow 121 passing through the filtered air recirculating channel 258 must be adapted, or cooled, with regard to the suction flow of the first outside air suction grooving 52 and with regard to the power of the first outside air suction grooving 52 and of the second air suction grooving 252.

According to an embodiment of the invention, illustrated in FIGS. 6, 7 and 8, the suction area 253 includes a first labyrinth 2530 for the passage of the air and/or a first baffle 2530 for the passage of the air. The pressure drop of the labyrinth 2530 of the suction area 253 makes it possible to minimize the stream of air coming from the inside of the compartment 31.

According to an embodiment of the invention, illustrated in the figures, the air collection area 254 includes a second labyrinth 2540 for the passage of the air and/or a second baffle 2540 for the passage of the air, for example at the air-guiding wall 2541 described below. This second labyrinth 2540 and/or this second baffle 2540 makes it possible to minimize mixing between the stream of air suctioned by the first outside air suction grooving 52 from the opening 324 of the upper part 323 of the wall 320 to the air collection area 254 (arrows AA of FIGS. 6, 7 and 8) and the stream of air sent by the second air suction grooving 252 from the suction area 253 to the air collection area 254, so as to avoid oil backing up from the compartment 31 to the first outside air suction grooving 52.

According to an embodiment of the invention, illustrated in FIGS. 6, 7 and 8, the air collection area 254 may include one (or more) air-guiding walls 2541. The air-guiding wall(s) 2541 is (or are) located at a distance between the first outside air suction grooving 52 and the second air suction grooving 252 and at a distance therefrom. Thus, the air-guiding wall (or walls) 2541 is (or are) located between the upper part 323 of the wall 320 and the lower part 321 of the wall 320 and/or between the upper intermediate air-expelling part 522 and the lower intermediate air-expelling part 523. The air-guiding wall (or walls) 2541 serve to guide, along a common guiding direction 2544 oriented toward the first air outlet 115, the air coming from the first outside air suction grooving 52 against a first face 2542 of the air-guiding wall 2541 and the air coming from the second air suction grooving 252 against a second face 2543 of the air-guiding wall 2541. The second face 2543 of the air-guiding wall 2541 is opposite the first face 2542 of the guiding wall 2541. The air collection area 254 further includes an air mixing area 2545 located at one end 2546 of the air-guiding wall 2541, which is located downstream along the guiding direction 2544 toward the first air outlet 115. The air mixing area 2545 is located between the air-guiding wall 2541 and the first air outlet 115. The air mixing area 2545 makes it possible to mix the air coming from the first outside air suction grooving 52 and the air coming from the second air suction grooving 252. The air-guiding wall 2541 makes it possible to further minimize mixing between the stream of air suctioned by the first outside air suction grooving 52 from the opening 324 of the upper part 323 of the wall 320 to the air collection area 254 (arrows AA of FIGS. 6, 7 and 8) and the stream of air sent by the second air suction grooving 252 from the suction area 253 to the air collection area 254, in such a way as to further avoid oil backing up from the compartment 31 toward the first outside air suction grooving 52. The air-guiding wall 2541 makes it possible to pre-orient these air streams along the common guiding direction 2544 oriented toward the first air outlet 115, to give the most tangential possible orientation to the two streams of air against the air-guiding wall 2541 and thus avoid their mixing to a great extent. Then, in the air mixing area 2545, the two streams of air will meet and go toward the first air outlet 115.

The first outside air suction grooving 52 accelerates the stream of air suctioned from the opening 324 of the upper part 323 of the wall 320 to the air collection area 254 (arrows AA of FIGS. 6, 7 and 8) and injects it into the air mixing area 2545.

According to an embodiment of the invention, illustrated in FIGS. 6, 7 and 8, the device 100 for filtering the air of the compartment 31 and for discharging the air to the outside 60 of the compartment 31 includes a second air inlet 112 connecting the first air outlet 115 to a filter 104, for example a coalescing filter. The filter 104 filters the oil-laden air 34 arriving in the air inlet 112 to separate the oil and the air and send the oil thus recovered to its filtered oil outlet 110, then to the compartment 31 via an oil channel 114 connecting the oil inlet 311 of the compartment 31 to this filtered oil outlet 110. The filter 104 sends the filtered air 120 to a filtered air pipe 105. The filtered air pipe 105 extends from the first filter 104 to a filtered air expelling accessway 102, vented to the outside 60 of the compartment 31. The air-filtering device 100 thus makes it possible to vent the oil 310 compartment 31, to filter the air 34 contained in the oil 310 compartment 31, to separate the air 34 from its oil droplets/vapor 39, to deliver to the outside 60 of the casing 32 the air 120 free of its oil 39, and return the oil condensate 39 extracted from the air 34 to the volume 310 of liquid oil of the compartment 31 via the outlet 110 and the inlet 311. The air 34 laden with oil 39 and particulate coming from the oil 310 compartment 31 passes through the filtering medium 150 of the filter(s) 104. The oil droplets and vapor 39 are separated from the air by the filtering medium 150. Once separated, the oil droplets 39 agglomerate into larger oil drops and descend through the filter 104 under gravity. The return of this oil condensate 39 to the oil 310 compartment 31 by the oil return system 110, 311 is characterized by the fact that it prevents the particulate-laden air 34, located in the casing 32 which is to be sealed, from bypassing the filter or filters 104 of the filtering system 100. For example, the oil inlet 311 is located above the oil level 313 of the volume 310 of liquid oil in the compartment 31; thus the return of the oil condensate 39 via this inlet 311 occurs above this oil level 313, in order to reduce the possible leakage points. The air 120 leaving the filtering element or elements 150 is decontaminated of its oil 39 and is expelled into the environment 60 of the rotating machine 10. The number of filters 104 equipping the venting device 100 is a function of several parameters, including in particular the performance of the sealing device 35, the level of contamination with particulate and with oil 39 of the air 34 located in the compartment 31, the desired maintenance schedule, and the characteristics of the filters 104 (pressure drop, efficiency of oil separation etc.) Of course, this embodiment may be combined with the different embodiments of the groovings 52 and 252.

According to another embodiment of the invention, not shown, the device 100 for filtering the air of the compartment 31 and for discharging the air to the outside 60 of the compartment 31, described above, moreover has the filtered air pipe 105 provided between the first filter 104 and an air suction accessway of a motor-driven fan for extracting air to the outside 60 of the compartment 31. An air-expelling outlet of the motor-driven fan for extracting air is vented to the outside 60 of the compartment 31. Of course, this embodiment may be combined with the different embodiments of the groovings 52 and 252.

In the first scenario of normal operation mentioned above, as shown in FIGS. 6 and 8, a relatively very small part of the air filtered by the venting device 100 comes from the inside of the compartment 31, so the air expelled after processing by the filtering system 104 via its filtered air expelling accessway 102 is extremely clean.

In the second scenario of degraded operation mentioned above, as shown in FIG. 7, part of the air filtered by the venting device 100 comes from the compartment 31. Experience feedback shows that despite the fact that this air of the compartment 31 is more laden with oil than in the first scenario of normal operation, the total volume of oil rejected into the oil channel 114 by the filtering system 104 over a year is non-zero and may be less than 1 liter.

The design according to the invention makes it possible to limit the passage of clean air into the roof of the oil compartment 31 (roof laden with oil vapor). Thus, in the first scenario of normal operation mentioned above, as shown in FIGS. 6 and 8, almost all the air suctioned by the second air suction grooving 252 comes from the air suction filter 256 (arrow CC). Hence, the air filtered by the venting device 100 is virtually devoid of oil vapor (arrows DD), and as a result the life of the filter 104 is longer and discharges of oil to the outside are very limited (and improved compared to the design as per WO2022/248220 A1).

According to an embodiment of the invention, illustrated in FIGS. 6 and 8, the wall 320, the first air inlet 255, the suction area 253, the first outside air suction grooving 52, the second air suction grooving 252, the opening 324 of the upper part 323 of the wall 320, the air collection area 254 and the first air outlet 115 are integral parts of a removable module 1000. The removable module 1000 includes a first connection joint for removably connecting the suction area 253 to the upper opening 322 of the casing 32. The removable module 1000 may include a second removable connection joint for removably connecting the first air outlet 115 to the second air inlet 112. The wall 320, the first air inlet 255, the suction area 253, the first outside air suction grooving 52, the second air suction grooving 252, the opening 324 of the upper part 323 of the wall 320, the air collection area 254 and the first air outlet 115 may be made as a single part 1000.

This removable module 1000 or this part 1000 make it possible to improve the integration of the device and increase its efficiency, by forming an “all-in-one” module 1000. This removable module 1000 or this part 1000 may thus be directly installed at the outlet of the shaft 33 of the rotating machine (instead and in place of a labyrinth seal for example) and makes it adaptable to as many machines as possible, the adaptations to be provided to install this removable module 1000 or this part 1000 being reduced to a minimum (great reduction in installation costs).

According to an embodiment of the invention, illustrated in FIG. 5, the rotating part 360 is an annular wall secured to the inertial flywheel 36 and extending around the rotary shaft 33. The inertial flywheel 36 extends transversally to the direction D of extension of the shaft 33. The rotating part 360 may be formed by an annular part which may take the form of a ring attached under the inertial flywheel 36. The wall 320 is located at a distance under the inertial flywheel 36. The sealing device 35 according to the invention is located at a distance under the inertial flywheel 36.

The invention also relates, as illustrated in FIGS. 3 to 8, to a primary motor-driven pump unit 2, intended to be mounted in at least one primary pressurized water circuit of a nuclear electrical power production plant, the primary motor-driven pump unit 2 including the primary pump 28 with a water pump impeller 280 and the rotating machine 10 as described above, the rotary shaft 33 of which is attached to the pump impeller 280 of the primary pump 28 for its rotational driving.

According to an embodiment of the invention, illustrated in FIGS. 3 to 8, the primary motor-driven pump unit 2 includes the inertial flywheel 36 attached to the rotary shaft 33, the rotating part 360 being an annular wall secured to the inertial flywheel 36 and extending around the rotary shaft 33.

Of course, the embodiments, possibilities and examples described above may be combined with the different embodiments of the groovings 52 and 252.

Of course, the embodiments, features, possibilities and examples described above may be combined with one another or be selected independently of one another.

1. A rotating machine, comprising a casing, at least one rotary shaft along a prescribed direction of rotation, at least one guide bearing, which is mounted in the casing and in which the at least one rotary shaft is rotatably mounted,
the casing delimiting a compartment intended to contain a volume of air and a volume of lubrication oil to lubricate the at least one guide bearing,
the rotating machine including, in an upper opening of the casing, a rotating part, which is rotationally attached to the at least one rotary shaft and which is surrounded, transversally to the at least one rotary shaft and at a distance from the at least one guide bearing, by a wall,
the rotating machine including an oil-sealing device, located between the rotating part and the wall, and a device for filtering the air of the compartment and for discharging the air to an outside of the compartment,
the oil-sealing device including at least one first outside air suction grooving for suctioning outside air in the prescribed direction of rotation of the at least one rotary shaft,
wherein the oil-sealing device includes, in a lower part of the wall and/or in a lower part of the rotating part, at least one second air suction grooving for suctioning air in the prescribed direction of rotation of the at least one rotary shaft from a suction area, which is located between the upper opening of the casing and the at least one second air suction grooving and which communicates firstly with the upper opening of the casing and secondly with a first air inlet,
the at least one second air suction grooving extending from the suction area to an air collection area and being configured to suction air from the compartment through the suction area and through the upper opening of the casing toward the air collection area when the at least one rotary shaft is rotating in the prescribed direction of rotation,
the air collection area being located between the at least one first outside air suction grooving and the at least one second air suction grooving and being connected to a first air outlet,
the at least one first outside air suction grooving being located in an upper part of the wall and/or in an upper part of the rotating part and being configured to suction air from an opening of the upper part of the wall toward the air collection area, when the at least one rotary shaft is rotating in the prescribed direction of rotation,
the device for filtering the air of the compartment and for discharging the air to the outside of the compartment including a second air inlet connected to the first air outlet, and further including a first filter for separating air and oil received at the second air inlet,
the first filter being able to send the oil having been filtered to a filtered oil outlet, connected to an oil inlet of the compartment.

2. The rotating machine as claimed in claim 1, wherein the first filter is configured to send the air having been filtered to a filtered air pipe provided between the first filter and an accessway for expelling filtered air, vented to the outside of the compartment.

3. The rotating machine as claimed in claim 1, wherein the first filter is configured to send the air having been filtered to a filtered air pipe provided between the first filter and an air suction accessway of a motor-driven fan for extracting air to the outside of the compartment.

4. The rotating machine as claimed in claim 1, wherein the first air inlet is connected to a second filter for suctioning air from the outside, the first air inlet being between the second filter and the suction area.

5. The rotating machine as claimed in claim 2, wherein the first air inlet is connected to the filtered air pipe and opens into the filtered air pipe between the first filter and the accessway.

6. The rotating machine as claimed in claim 1, wherein the suction area comprises a first labyrinth for the passage of the air and/or a first baffle for the passage of the air.

7. The rotating machine as claimed in claim 1, wherein the air collection area comprises a second labyrinth for the passage of the air and/or a second baffle for the passage of the air.

8. The rotating machine as claimed in claim 1, wherein the air collection area comprises at least one air-guiding wall, which is located at a distance between the at least one first outside air suction grooving and the at least one second air suction grooving and at a distance from these,
the at least one air-guiding wall extending along a common guiding direction of the air coming from the at least one first outside air suction grooving against a first face of the at least one air-guiding wall and of the air coming from the at least one second air suction grooving against a second face of the at least one air-guiding wall toward the first air outlet,
the second face of the at least one air-guiding wall being opposite the first face of the air-guiding wall,
the air collection area further comprising an air mixing area located at one end of the at least one air-guiding wall, which is located downstream along the common guiding direction,
the air mixing area being located between the at least one air-guiding wall and the first air outlet.

9. The rotating machine as claimed in claim 1, wherein the at least one first outside air suction grooving is inclined by a first determined, non-zero, angle of inclination with respect to a plane transverse to the at least one rotary shaft and extends around a direction of extension of the at least one rotary shaft, around which the at least one rotary shaft is configured to rotate in the prescribed direction of rotation,
the at least one second air suction grooving is inclined by a second determined, non-zero, angle of inclination with respect to the plane and extends around the direction of extension of the at least one rotary shaft,
the first determined, non-zero, angle being oriented in a reverse direction to the second determined, non-zero, angle with respect to the plane.

10. The rotating machine as claimed in claim 9, wherein the at least one first outside air suction grooving is helical around the direction of extension of the at least one rotary shaft,
the at least one second air suction grooving is helical around the prescribed direction of extension of the at least one rotary shaft.

11. The rotating machine as claimed in claim 1, wherein the wall, the first air inlet, the suction area, the at least one first outside air suction grooving, the at least one second air suction grooving, the opening of the upper part of the wall, the air collection area and the first air outlet are integral parts of a removable module, comprising at least one first removable connection fitting to removably connect the suction area to the upper opening of the casing.

12. A primary motor-driven pump unit, configured to be mounted in at least one pressurized primary water circuit of a nuclear electrical power production plant, the primary motor-driven pump unit comprising a primary pump with a water pump impeller and a rotating machine as claimed in claim 1, the at least one rotary shaft of which is attached to the pump impeller of the primary pump for its rotational driving rotationally driving the pump impeller.

13. The primary motor-driven pump unit as claimed in claim 12, wherein the primary motor-driven pump unit comprises an inertial flywheel attached to the at least one rotary shaft, the rotating part being an annular wall secured to the inertial flywheel and extending around the at least one rotary shaft.

14. The rotating machine as claimed in claim 3, wherein the first air inlet is connected to the filtered air pipe and opens into the filtered air pipe between the first filter and the accessway.
